(19) United States
(12) Patent Application Publication
(10) Pub. No.: US 2026/0176551 A1
(43) Pub. Date: Jun. 25, 2026

(54) CHLORIDE REMOVAL FROM BIO-OILS

(71) Applicant: UOP LLC, Rosemont, IL (US)

(72) Inventors: Vikrant Vilasrao Dalal, Gurugram (IN); Ankita Gupta, Gurugram (IN)

(21) Appl. No.: 19/418,440

(22) Filed: Dec. 12, 2025

Related U.S. Application Data
(60) Provisional application No. 63/736,481, filed on Dec. 19, 2024.

(51) Int. Cl. C11C 1/08; B01J 20/16; B01J 20/28

(52) U.S. Cl. CPC C11C 1/08; B01J 20/16; B01J 20/2803; B01J 20/28061; B01J 20/28064; B01J 2220/56

(57) ABSTRACT

Organic chlorides are removed from bio-oils, including vegetable oils and animal fats, that are to be coprocessed to meet sustainability goals. The organic chlorides are removed by using active materials such as silica-alumina containing adsorbents. The bio-oils that are targeted for treatment contain greater than 5 ppmw chlorides and are planned for more than 10% of the feedstream that is being processed.

### BACKGROUND OF THE INVENTION

Bio-oil is a form of liquid biofuel produced from diverse feedstocks such as crop residues, municipal wastes, algae, waste biomass and agricultural and forestry wastes. In some markets the bio-oils include vegetable oils, animal fats and used cooking fats. It usually contains a composite blend of deoxygenated compounds such as alcohols, ketones, carboxylic acids, esters, benzoids and aldehydes. Bio-oil is easy to handle, store and transport and processes high energy density. Notable applications of bio-oil include as a transportation fuel in internal combustion engines and for power generating plants. There is an increasing requirement for renewable fuels to be used in combination with petroleum-based fuels. More than 50% of European refiners are planning to co-process a renewable feed in their diesel hydrotreaters by 2030. The bio-oil needs to be purified before it is processed. One impurity that needs to be reduced to a very low level is chloride that is found in organochloride compounds.

### SUMMARY OF THE INVENTION

A process is provided for removing organic chloride compounds from a feedstream comprising about 5-300 ppm by wt chloride, said process comprising contacting said feed stream by physical adsorption with an adsorbent comprising an active material adsorbent to remove said chloride and produce a purified feedstream. The active material may be activated charcoal or a silica-alumina material. The active material comprises polar acidic sites which are sufficient to selectively remove organo-chloro-compounds from bio-oils. Active materials that exhibit such selective removal efficiency are but not limited to mixture of silica alumina, polar silica comprising moderate to weak acidic sites, with BET surface area above 450 m2/gm and average pore diameter 0.6° A and above as measured with Hg porosimetry.

### DETAILED DESCRIPTION OF THE INVENTION

Some of the components in bio-oil have significant chloride impurities. For example, vegetable oils may have about 10 ppmw and after becoming distressed from being heated they may have 10-30 ppmw chloride content. Animal fats may have about 200 ppmw and used cooking oil about 50 ppmw. The bio-oils used for co-processing need to have a maximum of 10 ppmw under the current European limits and preferably much less in anticipation of lower limits being imposed. One of the reasons for limitations on the chloride content is to reduce the production of hydrochloric acid. The goal is to remove the organic chlorides from the bio-oil mixtures. In particular, it is desirable to remove the chlorides from bio-oils where there is greater than 5 wppm chloride and a goal of the bio-oils comprising at least 10% of the feed being processed. The removal of the chlorides allows the refiner to be able to avoid expensive metallurgy upgrades that are necessary when the chlorides are not removed.

A process is provided for removing organic chloride compounds from a feedstream comprising about 5-300 ppm by wt chloride. The process comprises contacting the feed stream by physical adsorption with an adsorbent comprising an active material adsorbent to remove the chloride and producing a purified feedstream. Preferably, the adsorbent has a BET surface area greater than about 450 m²/g and an average pore diameter of about 0.6 Angstroms and above as measured by Hg porosimetry. The active material adsorbent may comprise an amorphous silica-alumina. The amorphous silica-alumina may comprise from about 40-80 wt % silica and 20-60 wt % alumina and preferably from about 50-70 wt % silica and 30-50 wt % alumina. The feedstream may comprise about 5-50 wppm chloride.

The active material adsorbent may be contained within a single adsorbent bed or a series of adsorbent beds such as three adsorbent beds in series. The feedstream sent to the adsorption bed is at a temperature from about 30-80° C. The feedstream sent to the adsorption bed is at a pressure from about 1-20 bar g. The feedstream may comprise one or more fatty acids containing bio-oils selected from vegetable oils, animal fats and used cooking oils.

The feedstream passes through an adsorption bed containing the active material adsorbent has about 25-50 percent of the organic chloride compounds per pass through the adsorption bed removed from the feedstream. More specifically, when the feedstream passes through the adsorption bed containing the active material adsorbent about 40 percent of the organic chloride compounds are removed from the feedstream per pass through said adsorption bed. The feedstream is passed through a series of adsorption beds until the feedstream comprises less than about 5 wppm chloride, preferably less than about 1 wppm chloride and most preferably less than about 0.5 wppm chloride. The feedstream may further comprise about 1-10 wppm or about 1-5 wppm phosphorus and the active material adsorbent removes about 60-99.9 wt % of the phosphorus from the feedstream. After the treatment to remove the organic chloride containing compounds, the purified feedstream may be sent to a hydroprocessing reactor. The feedstream sent to the adsorption bed is at a temperature from about 30-80° C. The feedstream sent to the adsorption bed is at a pressure from about 1-20 bar g.

### EXAMPLES

Several shake tests were performed to determine the capability of the active material adsorbent to remove chlorides from a used cooking oil feed at different temperatures.

### Example 1

Used cooking oil was included in a vessel with an active material adsorbent containing 20 wt % alumina binder. Different ratios of oil to adsorbent were compared including ratios of 8, 15, 30 and 100. The vessel was in container having a heated silica oil to maintain a temperature of 35, 100 or 150° C. Most testing was done over a 24-hour period unless otherwise indicated in Table 1.

TABLE 1

| | | | | | Gm | |
|---|---|---|---|---|---|---|
| Experiment | | Duration | Feed Cl | Oil Bath | feed/gm | Product Cl, |
| # | Feed | (hr) | wppm | Temp. ° C. | adsorbent | wppm |
| 1 | Used cooking | 24 | 17 | 35 | 30.0 | 13.7 |
| | oil | | | | | |
| 2 | Used cooking | 24 | 17 | 35 | 15.0 | 13.8 |
| | oil | | | | | |
| 3 | Used cooking | 24 | 17 | 35 | 8.2 | 13.6 |
| | oil | | | | | |
| 4 | Heptane with | 24 | 0.6 | 35 | 8.3 | 0.6 |
| | dichlorobutane | | | | | |
| 5 | Used cooking | 24 | 17 | 100 | 30.0 | 13.0 |
| | oil | | | | | |
| 6 | Used cooking | 24 | 17 | 100 | 15.0 | 13.3 |
| | oil | | | | | |
| 7 | Used cooking | 24 | 17 | 100 | 8.2 | 13.1 |
| | oil | | | | | |
| 8 | Used cooking | 24 | 17 | 150 | 30.0 | 11.8 |
| | oil | | | | | |
| 9 | Used cooking | 24 | 17 | 150 | 15.0 | 12.3 |
| | oil | | | | | |
| 10 | Used cooking | 24 | 17 | 150 | 8.2 | 12.0 |
| | oil | | | | | |
| 11 | Used cooking | 3, 8, 15, 24 | 17 | 35 | 8.2 | 8 hr: 13.9 |
| | oil | | | | | 15 hr 13.4 |
| 12 | Used cooking | 5, 15, 24 | 17 | 35 | 8.2 | 13.2/10.8/12.1 |
| | oil | | | | | |
| 13 | Filtered used | 5, 15, 24 | 20 | 35 | 8.2 | 12/11.7/11.5 |
| | cooking oil | | | | | |
| 14 | Used cooking | 24 | 17 | 35 | 8.2 | 10.5 |
| | oil | | | | | |

### Example 2

Another set of experiments were done as in Example 1 but this time with an adsorbent having a 10% alumina binder. The ratio of used cooking oil (feed) to adsorbent was 100, 200, 300 or 400. The shake test was again done for 24 hours but measurements were taken for up to 350 hours.

| | | | | Oil | Gm | |
|---|---|---|---|---|---|---|
| Experiment | | Duration | Feed Cl | Bath | feed/gm | Product Cl, |
| # | Feed | (hr) | wppm | Temp. ° C. | adsorbent | wppm |
| 1 | Used | 24 | 15.6 | 130 | 100 | 11.0 |
| | cooking oil | | | | | |
| 2 | Used | 24 | 15.6 | 130 | 200 | 10.0 |
| | cooking oil | | | | | |
| 3 | Used | 24 | 15.6 | 130 | 300 | 11.4 |
| | cooking oil | | | | | |
| 4 | Used | 24 | 15.6 | 150 | 400 | 11.0 |
| | Cooking Oil | | | | | |

Shake test continued for 13 days with sampling each day

| | | | | | | |
|---|---|---|---|---|---|---|
| 5 | Used | 48 | 15.6 | 150 | 400 | 11.0 |
| | cooking oil | | Initial | | | |
| 6 | | 72 | concentration | | | 11.0 |
| 7 | | 96 | | | | 10.8 |
| 8 | | 120 | | | | 10.6 |
| 9 | | 144 | | | | 10.9 |
| 10 | | 168 | | | | 10.8 |
| 11 | | 192 | | | | 10.6 |
| 12 | | 216 | | | | 10.6 |
| 13 | | 240 | | | | 10.6 |
| 14 | | 264 | | | | 10.5 |
| 15 | | 288 | | | | 10.6 |
| 16 | | 312 | | | | 10.0 |

It was observed that despite changing the ratio of feed to adsorbent from 100 to 400 that the product levels of chloride remained constant indicating that the adsorbent retained its dechlorination capacity. The range of 100 to 400 corresponds to about LHSV between 1 to 6/hr. It was calculated that the use of the adsorbent effectively removed chloride in the feed. The adsorbent had a capacity for about 1.0 kg Cl/m3. About 30% of the chloride was removed each time. The examples show that about 10-20% binder are effective adsorbents for use in removing chlorides.

### Specific Embodiments

While the following is described in conjunction with specific embodiments, it will be understood that this description is intended to illustrate and not limit the scope of the preceding description and the appended claims.

A first embodiment of the invention is a process for removing organic chloride compounds from a feedstream comprising about 5-300 ppm by wt chloride, the process comprising contacting the feed stream by physical adsorption with an adsorbent comprising an active material adsorbent to remove the chloride and produce a purified feedstream. An embodiment of the invention is one, any or all of prior embodiments in this paragraph up through the first embodiment in this paragraph wherein the adsorbent has a BET surface area greater than about 450 m2/g. An embodiment of the invention is one, any or all of prior embodiments in this paragraph up through the first embodiment in this paragraph wherein the active material adsorbent comprises an amorphous silica-alumina. An embodiment of the invention is one, any or all of prior embodiments in this paragraph up through the first embodiment in this paragraph wherein the feedstream comprises about 5-50 wppm chloride. An embodiment of the invention is one, any or all of prior embodiments in this paragraph up through the first embodiment in this paragraph wherein the active material adsorbent comprises from about 40-80 wt % silica and 20-60 wt % alumina. An embodiment of the invention is one, any or all of prior embodiments in this paragraph up through the first embodiment in this paragraph wherein the active material adsorbent comprises from about 50-70 wt % silica and 30-50 wt % alumina. An embodiment of the invention is one, any or all of prior embodiments in this paragraph up through the first embodiment in this paragraph wherein the active material adsorbent is contained within a single adsorbent bed or a series of adsorbent beds. An embodiment of the invention is one, any or all of prior embodiments in this paragraph up through the first embodiment in this paragraph wherein the feedstream comprises one or more fatty acids containing bio-oils selected from vegetable oils, animal fats and used cooking oils. An embodiment of the invention is one, any or all of prior embodiments in this paragraph up through the first embodiment in this paragraph wherein when the feedstream passes through an adsorption bed containing the active material adsorbent about 25-50 percent of the organic chloride compounds per pass through the adsorption bed are removed from the feedstream. An embodiment of the invention is one, any or all of prior embodiments in this paragraph up through the first embodiment in this paragraph wherein when the feedstream passes through an adsorption bed containing the active material adsorbent about 40 percent of the organic chloride compounds are removed from the feedstream per pass through the adsorption bed. An embodiment of the invention is one, any or all of prior embodiments in this paragraph up through the first embodiment in this paragraph wherein the feedstream is passed through a series of adsorption beds until the feedstream comprises less than about 5 wppm chloride. An embodiment of the invention is one, any or all of prior embodiments in this paragraph up through the first embodiment in this paragraph wherein the feedstream is passed through a series of adsorption beds until the feedstream comprises less than about 1 wppm chloride. An embodiment of the invention is one, any or all of prior embodiments in this paragraph up through the first embodiment in this paragraph wherein the feedstream is passed through a series of adsorption beds until the feedstream comprises less than about 0.5 wppm chloride. An embodiment of the invention is one, any or all of prior embodiments in this paragraph up through the first embodiment in this paragraph wherein the feedstream further comprises about 1-10 wppm phosphorus and the active material adsorbent removes about 60-99.9 wt % of the phosphorus from the feedstream. An embodiment of the invention is one, any or all of prior embodiments in this paragraph up through the first embodiment in this paragraph wherein the feedstream comprises 1-5 wppm phosphorus. An embodiment of the invention is one, any or all of prior embodiments in this paragraph up through the first embodiment in this paragraph wherein the purified feedstream is sent to a hydroprocessing reactor. An embodiment of the invention is one, any or all of prior embodiments in this paragraph up through the first embodiment in this paragraph wherein the feedstream sent to the adsorption bed is at a temperature from about 30-80° C. An embodiment of the invention is one, any or all of prior embodiments in this paragraph up through the first embodiment in this paragraph wherein the feedstream sent to the adsorption bed is at a pressure from about 1-20 bar g. An embodiment of the invention is one, any or all of prior embodiments in this paragraph up through the first embodiment in this paragraph wherein the active material adsorbent comprises about 10-20 wt % active material binder. An embodiment of the invention is one, any or all of prior embodiments in this paragraph up through the first embodiment in this paragraph wherein when the feedstream passes through an adsorption bed containing the active material adsorbent about 30 percent of the organic chloride compounds are removed from the feedstream per pass through the adsorption bed.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for removing organic chloride compounds from a feedstream comprising about 5-300 ppm by wt chloride, said process comprising contacting said feed stream by physical adsorption with an adsorbent comprising an active material adsorbent to remove said chloride and produce a purified feedstream.

2. The process of claim 1 wherein said adsorbent has a BET surface area greater than about 450 m2/g.

3. The process of claim 1 wherein said active material adsorbent comprises an amorphous silica-alumina.

4. The process of claim 1 wherein said feedstream comprises about 5-50 wppm chloride.

5. The process of claim 1 wherein said active material adsorbent comprises from about 40-80 wt % silica and 20-60 wt % alumina.

6. The process of claim 1 wherein said active material adsorbent comprises from about 50-70 wt % silica and 30-50 wt % alumina.

7. The process of claim 1 wherein said active material adsorbent is contained within a single adsorbent bed or a series of adsorbent beds.

8. The process of claim 1 wherein said feedstream comprises one or more fatty acids containing bio-oils selected from vegetable oils, animal fats and used cooking oils.

9. The process of claim 1 wherein when said feedstream passes through an adsorption bed containing said active material adsorbent about 25-50 percent of the organic chloride compounds per pass through said adsorption bed are removed from said feedstream.

10. The process of claim 1 wherein when said feedstream passes through an adsorption bed containing said active material adsorbent about 40 percent of the organic chloride compounds are removed from said feedstream per pass through said adsorption bed.

11. The process of claim 1 wherein said feedstream is passed through a series of adsorption beds until said feedstream comprises less than about 5 wppm chloride.

12. The process of claim 1 wherein said feedstream is passed through a series of adsorption beds until said feedstream comprises less than about 1 wppm chloride.

13. The process of claim 1 wherein said feedstream is passed through a series of adsorption beds until said feedstream comprises less than about 0.5 wppm chloride.

14. The process of claim 1 wherein said feedstream further comprises about 1-10 wppm phosphorus and said active material adsorbent removes about 60-99.9 wt % of the phosphorus from said feedstream.

15. The process of claim 11 wherein said feedstream comprises 1-5 wppm phosphorus.

16. The process of claim 1 wherein said purified feedstream is sent to a hydroprocessing reactor.

17. The process of claim 1 wherein said feedstream sent to said adsorption bed is at a temperature from about 30-80° C.

18. The process of claim 1 wherein said feedstream sent to said adsorption bed is at a pressure from about 1-20 bar g.

19. The process of claim 1 wherein said active material adsorbent comprises about 10-20 wt % active material binder.

20. The process of claim 1 wherein when said feedstream passes through an adsorption bed containing said active material adsorbent about 30 percent of the organic chloride compounds are removed from said feedstream per pass through said adsorption bed.
